(19) United States
(12) Patent Application Publication
(10) Pub. No.: US 2020/0406388 A1
(43) Pub. Date: Dec. 31, 2020

(54) METHOD OF RESISTANCE WELDING ZINC COATED STEEL

(71) Applicant: GM Global Technology Operations LLC, Detroit, MI (US)

(72) Inventors: Pei-chung Wang, Troy, MI (US); Michael J. Karagoulis, Okemos, MI (US); Spyros P. Mellas, Waterford, MI (US); Zhenke Teng, Troy, MI (US)

(21) Appl. No.: 16/457,002

(22) Filed: Jun. 28, 2019

(51) Int. Cl. B23K 11/16

(52) U.S. Cl. CPC B23K 11/16; B23K 2103/04

(57) ABSTRACT

A method of resistance welding includes providing a first steel workpiece and second steel workpiece each having a zinc (Zn) coating. A first portion of the first steel workpiece and a second portion of the second steel workpiece are heated to at least about 500° C. allowing the zinc (Zn) coating to melt and dissolution of iron Fe from the first and second steel workpieces into the melted zinc (Zn) coating to form at least one of a plurality of Iron-Zinc intermetallic compounds. The first portion of the first workpiece and the second portion of the second workpiece are cooled to a first temperature. The first workpiece is disposed in contact with the second workpiece such that the first portion of the first workpiece is aligned with the second portion of the second workpiece. The first portion of the first workpiece is welded to the second portion of the second workpiece.

The present disclosure relates generally to a method of resistance welding zinc coated steel and more particularly for a method of avoiding liquid metal embrittlement failures of resistance welded zinc coated steel.

A zinc coating applied to steel is useful for corrosion protection. For automobile applications, zinc coated or galvanized steel is purchased, stamped or otherwise shaped, and welded with other pieces to manufacture corrosion resistant body structures or frame components. One of the most efficient methods of joining steel parts is through welding and resistance welding in particular. However, resistance welding zinc coated steel has proven difficult due to a phenomenon known as liquid metal embrittlement (LME) which causes cracks in the surface of the steel around the areas that are welded.

Accordingly, there is a need for a new method of resistance welding that eliminates the LME phenomenon, provides sound weld joints, and produces corrosion resistant steel structures for vehicles.

### SUMMARY

A method of resistance welding is provided. The method includes providing a first workpiece and a second workpiece. A first portion of the first workpiece and a second portion of the second workpiece are heated to a first temperature. The first portion of the first workpiece and the second portion of the second workpiece are cooled to a second temperature. The first workpiece is disposed in contact with the second workpiece such that the first portion of the first workpiece is aligned with the second portion of the second workpiece. The first portion of the first workpiece and the second portion of the second workpiece are welded.

In one example of the present disclosure, providing a first workpiece and a second workpiece further comprises providing a first steel workpiece and second steel workpiece.

In another example of the present disclosure, providing a first steel workpiece and second steel workpiece further comprises providing the first steel workpiece and the second steel workpiece and wherein at least one of the first and second workpieces have a coating.

In yet another example of the present disclosure, providing a first steel workpiece and second steel workpiece further comprises providing a first steel workpiece and second steel workpiece and wherein at least one of the first and second workpieces have a zinc (Zn) coating.

In yet another example of the present disclosure, heating a first portion of the first steel workpiece and a second portion of the second steel workpiece to a first temperature further comprises heating a first portion of the first workpiece and a second portion of the second workpiece to at least 420° C. that allows for dissolution of iron Fe from the first and second steel workpieces into the liquefied zinc (Zn) coating to form at least one of a plurality of Iron-Zinc intermetallic compounds.

In yet another example of the present disclosure, heating a first portion of the first steel workpiece and a second portion of the second steel workpiece to a first temperature further comprises heating a first portion of the first workpiece and a second portion of the second workpiece to at least 420° C. that allows for dissolution of iron Fe from the first and second steel workpieces into the liquefied zinc (Zn) coating to form at least one of Fe₃Zn₁₀, FeZn₁₀, and FeZn₁₃.

In yet another example of the present disclosure, heating a first portion of the first workpiece and a second portion of the second workpiece to a first temperature further comprises heating a first portion of the first workpiece and a second portion of the second workpiece to at least about 420° C.

In yet another example of the present disclosure, heating a first portion of the first workpiece and a second portion of the second workpiece to a first temperature further comprises heating a first portion of the first workpiece and a second portion of the second workpiece to at least about 500° C.

In yet another example of the present disclosure, heating a first portion of the first workpiece and a second portion of the second workpiece to a first temperature further comprises heating a first portion of the first workpiece and a second portion of the second workpiece to a range of about 500° C. to about 565° C.

In yet another example of the present disclosure, providing a first workpiece and a second workpiece further comprises providing a first workpiece, a second workpiece, and a third workpiece.

In yet another example of the present disclosure, heating a first portion of the first workpiece and a second portion of the second workpiece to a first temperature further comprises heating a first portion of the first workpiece, a second portion of the second workpiece, and a third portion of the third workpiece to a first temperature.

In yet another example of the present disclosure, cooling the first portion of the first workpiece and the second portion of the second workpiece to a second temperature further comprises cooling the first portion of the first workpiece, the second portion of the second workpiece, and the third portion of the third workpiece to a second temperature.

In yet another example of the present disclosure, disposing the first workpiece in contact with the second workpiece such that the first portion of the first workpiece is aligned with the second portion of the second workpiece further comprises disposing the first workpiece in contact with the second workpiece and the third workpiece such that the first portion of the first workpiece is aligned with the second portion of the second workpiece and the third portion of the third workpiece.

In yet another example of the present disclosure, welding the first portion of the first workpiece to the second portion of the second workpiece further comprises welding the first portion of the first workpiece to the second portion of the second workpiece and the second portion of the second workpiece to the third portion of the third workpiece.

Another method of resistance welding is provided. The method includes providing a first steel workpiece and second steel workpiece. A first portion of the first workpiece and a second portion of the second workpiece are heated to at least 420° C. The first portion of the first workpiece and the second portion of the second workpiece are cooled to a second temperature. The first workpiece is disposed in contact with the second workpiece such that the first portion of the first workpiece is aligned with the second portion of the second workpiece. The first portion of the first workpiece is welded to the second portion of the second workpiece.

In one example of the present disclosure, providing a first steel workpiece and second steel workpiece further comprises providing the first steel workpiece and the second steel workpiece and wherein at least one of the first and second workpieces have a zinc (Zn) coating.

In another example of the present disclosure, heating a first portion of the first workpiece and a second portion of the second workpiece to at least 420° C. further comprises heating a first portion of the first workpiece and a second portion of the second workpiece to at least 420° C. that allows for dissolution of iron Fe from the first and second steel workpieces into the liquefied zinc (Zn) coating to form at least one of a plurality of Iron-Zinc intermetallic compounds.

In yet another example of the present disclosure, heating a first portion of the first steel workpiece and a second portion of the second steel workpiece to a first temperature further comprises heating a first portion of the first workpiece and a second portion of the second workpiece to at least 420° C. that allows for dissolution of iron Fe from the first and second steel workpieces into the liquefied zinc (Zn) coating to form at least one of Fe₃Zn₁₀, FeZn₁₀, and FeZn₁₃.

In yet another example of the present disclosure, heating a first portion of the first workpiece and a second portion of the second workpiece to a first temperature further comprises heating a first portion of the first workpiece and a second portion of the second workpiece to at least about 500° C.

In yet another example of the present disclosure, heating a first portion of the first workpiece and a second portion of the second workpiece to a first temperature further comprises heating a first portion of the first workpiece and a second portion of the second workpiece to a range of about 500° C. to about 565° C.

In yet another example of the present disclosure, cooling the first portion of the first workpiece and the second portion of the second workpiece to a second temperature further comprises cooling the first portion of the first workpiece and the second portion of the second workpiece to below about 100° C.

Yet another method of resistance welding is provided. The method includes providing a first steel workpiece and second steel workpiece. Each of the first and second workpieces have a zinc (Zn) coating. A first portion of the first steel workpiece and a second portion of the second steel workpiece are heated to at least about 500° C. allowing the zinc (Zn) coating to melt and dissolution of iron Fe from the first and second steel workpieces into the melted zinc (Zn) coating to form at least one of a plurality of Iron-Zinc intermetallic compounds. The first portion of the first workpiece and the second portion of the second workpiece are cooled to a first temperature. The first workpiece is disposed in contact with the second workpiece such that the first portion of the first workpiece is aligned with the second portion of the second workpiece. The first portion of the first workpiece is welded to the second portion of the second workpiece.

In one example of the present disclosure, heating a first portion of the first steel workpiece and a second portion of the second steel workpiece to at least about 500° C. allowing the zinc (Zn) coating to melt and dissolution of iron Fe from the first and second steel workpieces into the melted zinc (Zn) coating to form at least one of a plurality of Iron-Zinc intermetallic compounds further comprises heating a first portion of the first steel workpiece and a second portion of the second steel workpiece to a range of about 500° C. to about 565° C. allowing the zinc (Zn) coating to melt and dissolution of iron Fe from the first and second steel workpieces into the melted zinc (Zn) coating to form at least one of a plurality of Fe₃Zn₁₀, FeZn₁₀, and FeZn₁₃.

In another example of the present disclosure, providing a first steel workpiece and second steel workpiece, and wherein each of the first and second workpieces have a zinc (Zn) coating further comprises providing a first steel workpiece, a second steel workpiece, and a third steel workpiece, and wherein each of the first, second, and third steel workpieces have a zinc (Zn) coating.

In yet another example of the present disclosure, heating a first portion of the first steel workpiece and a second portion of the second steel workpiece to at least about 500° C. allowing the zinc (Zn) coating to melt and the dissolution of iron Fe from the first and second steel workpieces into the melted zinc (Zn) coating to form at least one of a plurality of Iron-Zinc intermetallic compounds further comprises heating a first portion of the first steel workpiece, a second portion of the second steel workpiece, and a third portion of the third steel workpiece to at least about 500° C. allowing the zinc (Zn) coating to melt and the dissolution of iron Fe from the first, second, and third steel workpieces into the melted zinc (Zn) coating to form at least one of a plurality of Iron-Zinc intermetallic compounds.

In yet another example of the present disclosure, cooling the first portion of the first steel workpiece and the second portion of the second steel workpiece to a first temperature further comprises cooling the first portion of the first steel workpiece, the second portion of the second steel workpiece, and the third portion of the third workpiece to a first temperature.

In yet another example of the present disclosure, disposing the first steel workpiece in contact with the second steel workpiece such that the first portion of the first steel workpiece is aligned with the second portion of the second steel workpiece further comprising disposing the first steel workpiece in contact with the second steel workpiece and the second steel workpiece in contact with the third steel workpiece such that the first portion of the first steel workpiece is aligned with the second portion of the second steel workpiece and the third portion of the third steel workpiece.

In yet another example of the present disclosure, welding the first portion of the first steel workpiece to the second portion of the second steel workpiece further comprises welding the first portion of the first steel workpiece to the second portion of the second steel workpiece and the third portion of the third steel workpiece.

The above features and advantages and other features and advantages of the present disclosure are readily apparent from the following detailed description when taken in connection with the accompanying drawings.

### BRIEF DESCRIPTION OF THE DRAWING

The drawings described herein are for illustration purposes only and are not intended to limit the scope of the present disclosure in any way.

FIG. 1 is a cross-section of a zinc coated steel workpiece according to the principles of the present disclosure;

FIG. 2 is a cross-section of a zinc coated steel workpiece and a heating element according to the principles of the present disclosure;

FIG. 3 is a cross-section of a zinc coated steel workpiece treated with a heating element according to the principles of the present disclosure;

FIG. 4 is a cross-section of a pair of treated zinc coated steel workpieces according to the principles of the present disclosure;

FIG. 5 is a cross-section of a pair of treated zinc coated steel workpieces and a resistance welding apparatus according to the principles of the present disclosure;

FIG. 6 is a cross-section of a pair of treated and welded zinc coated treated steel workpieces according to the principles of the present disclosure;

FIG. 7 is a cross-section of a zinc coated steel workpiece according to the principles of the present disclosure;

FIG. 8 is a cross-section of a zinc coated steel workpiece and a heating element according to the principles of the present disclosure;

FIG. 9 is a cross-section of a zinc coated and partially treated steel workpiece and a heating element according to the principles of the present disclosure;

FIG. 10 is a cross-section of a zinc coated and treated steel workpiece according to the principles of the present disclosure;

FIG. 11 is a cross-section of a pair of zinc coated and treated steel workpieces according to the principles of the present disclosure;

FIG. 12 is a cross-section of a pair of treated zinc coated steel workpieces and a resistance welding apparatus according to the principles of the present disclosure;

FIG. 13 is a micrograph of an untreated welded zinc coated steel workpiece according to the principles of the present disclosure;

FIG. 14 is a micrograph of a treated zinc coated steel workpiece according to the principles of the present disclosure; and

FIG. 15 is a micrograph of a treated welded zinc coated steel workpiece according to the principles of the present disclosure.

### DESCRIPTION

The following description is merely exemplary in nature and is not intended to limit the present disclosure, application, or uses. The term “about” as used in the description is defined as an amount around a specific number that does not have a significant impact on the results of the operation.

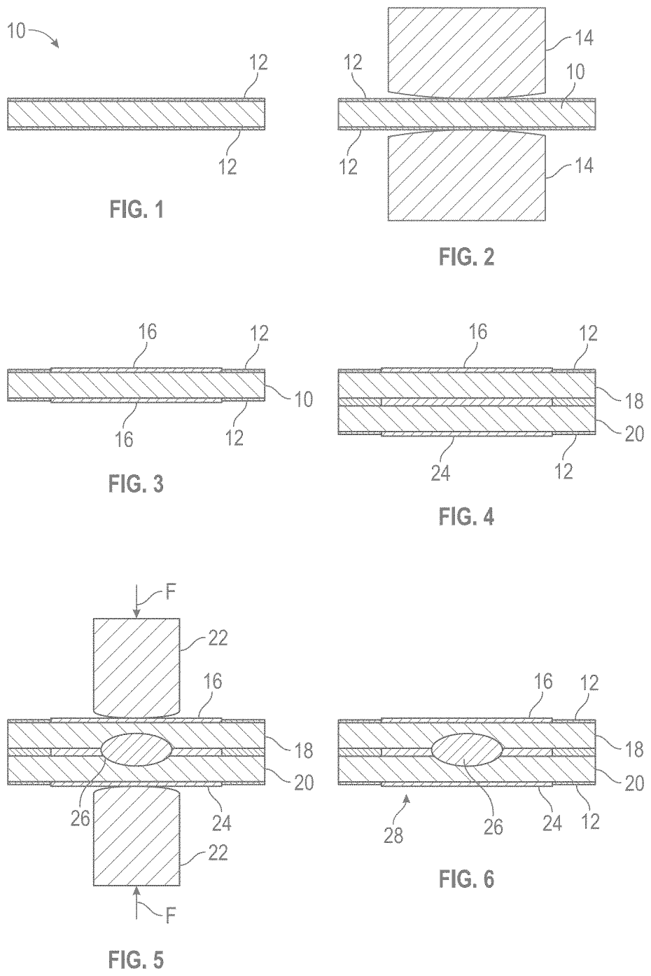

Referring to FIGS. 1-6, a method of resistance welding zinc coated or galvanized steel is illustrated and will now be described. FIGS. 1 and 2 show a first steel workpiece 10 with a zinc (Zn) coating 12 having a localized heating element 14. The localized heating element 14 uses a resistance heating element, however, other examples of the present disclosure may include an induction heating element or other type of heat source without departing from the scope of the present disclosure. More particularly, the heating element 14 heats a first portion 16 of the first steel workpiece 10 to a temperature of at least 420° C., the melting temperature of pure zinc (Zn). Preferably, the heating element 14 heats the first portion 16 of the first steel workpiece 10 to a temperature range between about 500° C. to about 565° C. Upon reaching this temperature range, the zinc (Zn) coating 12 melts into a liquid zinc (Zn) pool. Iron (Fe) from the first steel workpiece 10 reacts with the liquid zinc (Zn) pool and forms several intermetallic iron-zinc (Fe—Zn) compounds. Namely, Fe₃Zn₁₀, FeZn₁₀, and FeZn₁₃ form as the diffusion of iron Fe is precipitated by melting the zinc (Zn) coating 12 and subsequent heating of the first steel workpiece 10. As prescribed, the newly formed iron-zinc (Fe—Zn) compounds having a melting temperature of 782° C., 665° C., and 530° C. The first steel workpiece 10 is now a first treated steal workpiece 18.

The first treated steel workpiece 18 is combined with a second treated steel workpiece 20 as in FIGS. 4 and 5. A resistance welding apparatus 22 applies a force F to the first portion 16 of the first treated steel workpiece 18 after it is aligned with a second portion 24 of the second treated steel workpiece 20. The resistance welding apparatus 22 is energized and welds 26 the first portion 16 of the first treated steel workpiece 18 to the second portion 24 of the second treated steel workpiece 20 forming an assembly 28 shown in FIG. 6. While the present example describes a method for joining a first treated steel workpiece 18 with a second treated steel workpiece 20, welding multiple treated steel workpieces together with this method may be considered without departing from the scope of the present disclosure.

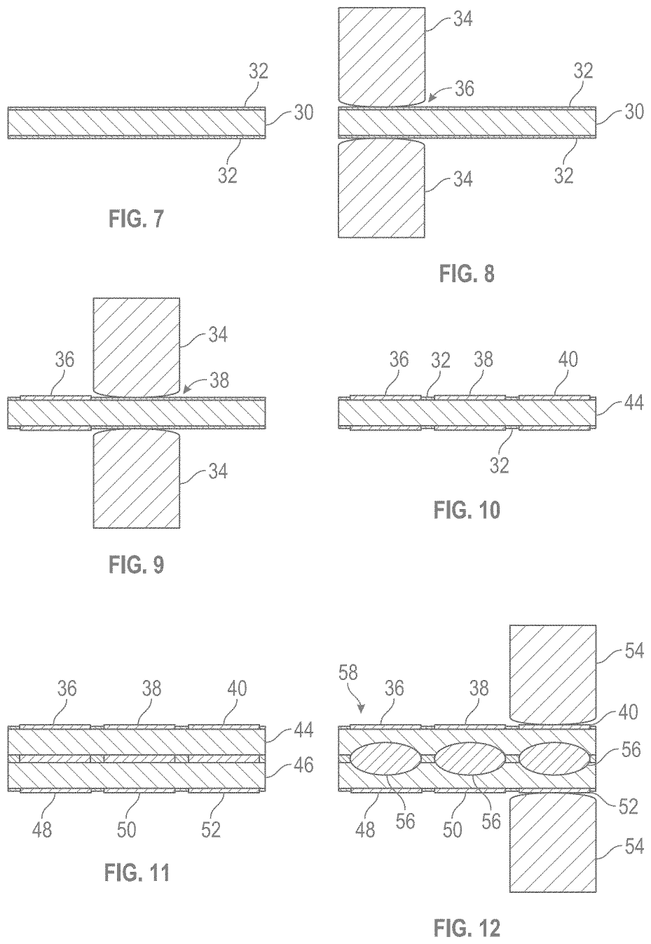

Turning now to FIGS. 7-12, another method of resistance welding zinc coated or galvanized steel is illustrated and will now be described. FIGS. 7 and 8 show a first steel workpiece 30 with a zinc (Zn) coating 32 having a localized heating element 34. More particularly, the heating element 34 heats a first portion 36 of the first steel workpiece 30 to a temperature of at least 420° C., the melting temperature of pure zinc (Zn). Preferably, the heating element 34 heats the first portion 36 of the first steel workpiece 10 to a temperature range between about 500° C. to about 565° C. FIGS. 9 and 10 depict a second portion 38 and a third portion 40 of the first steel workpiece 30 and the heating element 34 progressively heating the second and third portions 38, 40 of the first steel workpiece forming a first treated steel workpiece 44. Upon reaching this temperature range, the zinc (Zn) coating 32 melts into a liquid zinc (Zn) pool in the first, second, and third portions 36, 38, 40. As stated previously, Iron (Fe) from the first steel workpiece 30 reacts with the liquid zinc (Zn) pools and forms several intermetallic iron-zinc (Fe—Zn) compounds. Namely, Fe₃Zn₁₀, FeZn₁₀, and FeZn₁₃ form as the diffusion of iron (Fe) is precipitated by melting the zinc (Zn) coating 12 and subsequent heating of the first steel workpiece 30. As prescribed, the newly formed iron-zinc (Fe—Zn) compounds having a melting temperature of 782° C., 665° C., and 530° C. The first steel workpiece 30 is now a first treated steal workpiece 44.

The first treated steel workpiece 44 is combined with a second treated steel workpiece 46 having a fourth, fifth, and sixth portions 48, 50, 52, which was formed in the same manner as the first treated steel workpiece 44, as in FIGS. 11 and 12. A resistance welding apparatus 54 applies a force F to the first portion 36 of the first treated steel workpiece 44 after it is aligned with a fourth portion 48 of the second treated steel workpiece 46. The resistance welding apparatus 54 is energized and welds 56 the first portion 36 of the first treated steel workpiece 18 to the fourth portion 48 of the second treated steel workpiece 46. Subsequent welding is completed thus joining the second portion 38 of the first treated steel workpiece 44 to the fifth portion 50 of the second treated steel workpiece 46 and the third portion 40 of the first treated steel workpiece 44 to the sixth portion 52 of the second treated steel workpiece 46. The new assembly 58 is shown in FIG. 12. As with the method described previously, while the present example describes a method for joining a first treated steel workpiece 44 with a second treated steel workpiece 46, welding multiple treated steel workpieces together with this method may be considered without departing from the scope of the present disclosure.

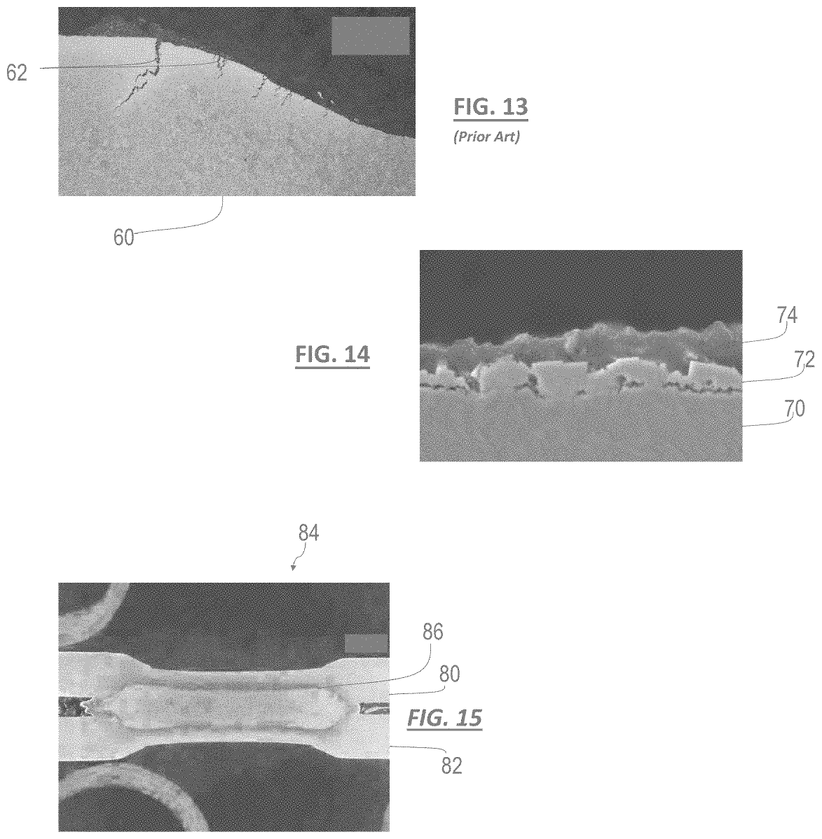

Referring now to FIGS. 13-15, a series of micrographs showing the effect of the methods as described above are shown and will now be described. FIG. 13, for example, is a micrograph of the resistance welded portion of a zinc coated steel workpiece 60 having several micro cracks 62 due to liquid metal embrittlement (LME). Due to liquid zinc being on the surface of the steel workpiece penetrates and diffuses into the grain boundaries and the tensile internal stresses developed during the welding and solidification, liquid metal embrittlement cracking forms on the surface of the workpiece, and consequently leads to the loss of ductility of the workpiece.

An example of a treated workpiece 70 is shown in FIG. 14. The treated workpiece 70 has a first layer 72 including the resulting intermetallic Fe—Zn compounds formed after the temperature of the surface of the workpiece is heated to between about 500° C. to about 565° C. and cooled. A second layer 74 is a portion of the zinc (Zn) coating that did not have enough iron (Fe) diffused into it to form the intermetallic Fe—Zn compounds.

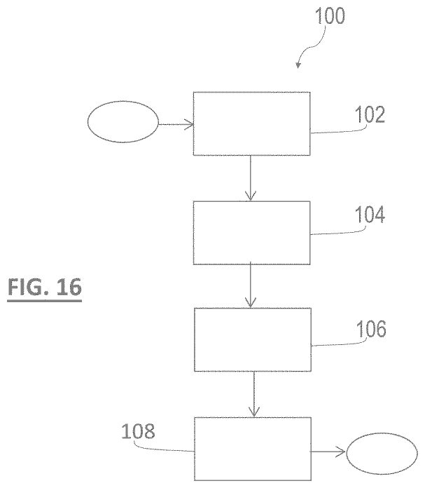

The joined workpieces 80, 82 of the assembly 84 of FIG. 15 shows the effect of forming the layer of intermetallic Fe—Zn compounds on the surface of the workpieces prior to resistance welding the workpieces together. The surfaces of the workpieces surrounding the weld 86 are free of surface cracks.

Turning now to FIG. 16, a flowchart depicting a method of resistance welding zinc (Zn) coated steel is illustrated and will now be described. The method 100 begins with a first step 102 of providing the first and second zinc coated steel workpieces 10, 20, referring to FIGS. 1 to 6. A second step 104 heats a portion of each of the zinc (Zn) coated steel workpieces 10, 20 to a range of about 500° C. to about 565° C. This temperature is above the melting point of pure zinc (Zn) thus the zinc (Zn) coating melts. Also, iron (Fe) from the steel reacts with the liquid zinc (Zn) forming iron-zinc (Fe—Zn) intermetallic compounds such as Fe₃Zn₁₀, FeZn₁₀, and FeZn₁₃. A third step 106 cools the workpieces 10, 20. In some examples, several cycles of heating different portions of a particular workpiece can occur prior to cooling. The main reason for cooling the workpiece is to avoid preheating the weld portion causing overheating. Still, the second step 104 can be completed offline as a separate operation prior to welding. Alternatively, the second step 104 can be a part of the on-line welding and assembly process without departing from the scope of the present disclosure.

A fourth step 108 arranges the workpieces and resistant welds the workpieces together by placing welds at the portions of the workpieces that were pretreated with heat in the second step 104.

While examples have been described in detail, those familiar with the art to which this disclosure relates will recognize various alternative designs and examples for practicing the disclosed structure within the scope of the appended claims.

The following is claimed:

1. A method of resistance welding, the method comprising:
providing a first workpiece and a second workpiece;
heating a first portion of the first workpiece and a second portion of the second workpiece to a first temperature;
cooling the first portion of the first workpiece and the second portion of the second workpiece to a second temperature;
disposing the first workpiece in contact with the second workpiece such that the first portion of the first workpiece is aligned with the second portion of the second workpiece; and
welding the first portion of the first workpiece to the second portion of the second workpiece.

2. The method of claim 1 wherein providing a first workpiece and a second workpiece further comprises providing a first steel workpiece and second steel workpiece.

3. The method of claim 2 wherein providing a first steel workpiece and second steel workpiece further comprises providing the first steel workpiece and the second steel workpiece and wherein at least one of the first and second workpieces have a coating.

4. The method of claim 2 wherein providing a first steel workpiece and second steel workpiece further comprises providing a first steel workpiece and second steel workpiece and wherein at least one of the first and second workpieces have a zinc (Zn) coating.

5. The method of claim 4 wherein heating a first portion of the first steel workpiece and a second portion of the second steel workpiece to a first temperature further comprises heating a first portion of the first workpiece and a second portion of the second workpiece to at least 420° C. that allows for dissolution of iron Fe from the first and second steel workpieces into the liquefied zinc (Zn) coating to form at least one of a plurality of Iron-Zinc intermetallic compounds.

6. The method of claim 4 wherein heating a first portion of the first steel workpiece and a second portion of the second steel workpiece to a first temperature further comprises heating a first portion of the first workpiece and a second portion of the second workpiece to at least 420° C. that allows for dissolution of iron Fe from the first and second steel workpieces into the liquefied zinc (Zn) coating to form at least one of Fe₃Zn₁₀, FeZn₁₀, and FeZn₁₃.

7. The method of claim 1 wherein heating a first portion of the first workpiece and a second portion of the second workpiece to a first temperature further comprises heating a first portion of the first workpiece and a second portion of the second workpiece to at least about 420° C.

8. The method of claim 1 wherein heating a first portion of the first workpiece and a second portion of the second workpiece to a first temperature further comprises heating a first portion of the first workpiece and a second portion of the second workpiece to at least about 500° C.

9. The method of claim 1 wherein heating a first portion of the first workpiece and a second portion of the second workpiece to a first temperature further comprises heating a first portion of the first workpiece and a second portion of the second workpiece to a range of about 500° C. to about 565° C.

10. The method of claim 1 wherein:
providing a first workpiece and a second workpiece further comprises providing a first workpiece, a second workpiece, and a third workpiece;
heating a first portion of the first workpiece and a second portion of the second workpiece to a first temperature further comprises heating a first portion of the first workpiece, a second portion of the second workpiece, and a third portion of the third workpiece to a first temperature;
cooling the first portion of the first workpiece and the second portion of the second workpiece to a second temperature further comprises cooling the first portion of the first workpiece, the second portion of the second workpiece, and the third portion of the third workpiece to a second temperature;
disposing the first workpiece in contact with the second workpiece such that the first portion of the first workpiece is aligned with the second portion of the second workpiece further comprises disposing the first workpiece in contact with the second workpiece and the third workpiece such that the first portion of the first workpiece is aligned with the second portion of the second workpiece and the third portion of the third workpiece; and
welding the first portion of the first workpiece to the second portion of the second workpiece further comprises welding the first portion of the first workpiece to the second portion of the second workpiece and the second portion of the second workpiece to the third portion of the third workpiece.

11. A method of resistance welding, the method comprising:
providing a first steel workpiece and second steel workpiece;
heating a first portion of the first workpiece and a second portion of the second workpiece to at least 420° C.;
cooling the first portion of the first workpiece and the second portion of the second workpiece to a second temperature;
disposing the first workpiece in contact with the second workpiece such that the first portion of the first workpiece is aligned with the second portion of the second workpiece; and
welding the first portion of the first workpiece to the second portion of the second workpiece.

12. The method of claim 11 wherein providing a first steel workpiece and second steel workpiece further comprises providing the first steel workpiece and the second steel workpiece and wherein at least one of the first and second workpieces have a zinc (Zn) coating.

13. The method of claim 12 wherein heating a first portion of the first workpiece and a second portion of the second workpiece to at least 420° C. further comprises heating a first portion of the first workpiece and a second portion of the second workpiece to at least 420° C. that allows for dissolution of iron Fe from the first and second steel workpieces into the liquefied zinc (Zn) coating to form at least one of a plurality of Iron-Zinc intermetallic compounds.

14. The method of claim 13 wherein heating a first portion of the first steel workpiece and a second portion of the second steel workpiece to a first temperature further comprises heating a first portion of the first workpiece and a second portion of the second workpiece to at least 420° C. that allows for dissolution of iron Fe from the first and second steel workpieces into the liquefied zinc (Zn) coating to form at least one of Fe₃Zn₁₀, FeZn₁₀, and FeZn₁₃.

15. The method of claim 11 wherein heating a first portion of the first workpiece and a second portion of the second workpiece to a first temperature further comprises heating a first portion of the first workpiece and a second portion of the second workpiece to at least about 500° C.

16. The method of claim 11 wherein heating a first portion of the first workpiece and a second portion of the second workpiece to a first temperature further comprises heating a first portion of the first workpiece and a second portion of the second workpiece to a range of about 500° C. to about 565° C.

17. The method of claim 16 wherein cooling the first portion of the first workpiece and the second portion of the second workpiece to a second temperature further comprises cooling the first portion of the first workpiece and the second portion of the second workpiece to below about 100° C.

18. A method of resistance welding, the method comprising:
providing a first steel workpiece and second steel workpiece, and wherein each of the first and second steel workpieces have a zinc (Zn) coating;
heating a first portion of the first steel workpiece and a second portion of the second steel workpiece to at least about 500° C. allowing the zinc (Zn) coating to melt and the dissolution of iron Fe from the first and second steel workpieces into the melted zinc (Zn) coating to form at least one of a plurality of Iron-Zinc intermetallic compounds;
cooling the first portion of the first steel workpiece and the second portion of the second steel workpiece to a first temperature;
disposing the first steel workpiece in contact with the second steel workpiece such that the first portion of the first steel workpiece is aligned with the second portion of the second steel workpiece; and
welding the first portion of the first steel workpiece to the second portion of the second steel workpiece.

19. The method of claim 18 wherein heating a first portion of the first steel workpiece and a second portion of the second steel workpiece to at least about 500° C. allowing the zinc (Zn) coating to melt and dissolution of iron Fe from the first and second steel workpieces into the melted zinc (Zn) coating to form at least one of a plurality of Iron-Zinc intermetallic compounds further comprises heating a first portion of the first steel workpiece and a second portion of the second steel workpiece to a range of about 500° C. to about 565° C. allowing the zinc (Zn) coating to melt and dissolution of iron Fe from the first and second steel workpieces into the melted zinc (Zn) coating to form at least one of a plurality of Fe₃Zn10, FeZn₁₀, and FeZn₁₃.

20. The method of claim 18 wherein:
providing a first steel workpiece and second steel workpiece, and wherein each of the first and second workpieces have a zinc (Zn) coating further comprises providing a first steel workpiece, a second steel workpiece, and a third steel workpiece, and wherein each of the first, second, and third steel workpieces have a zinc (Zn) coating;
heating a first portion of the first steel workpiece and a second portion of the second steel workpiece to at least about 500° C. allowing the zinc (Zn) coating to melt and the dissolution of iron Fe from the first and second steel workpieces into the melted zinc (Zn) coating to form at least one of a plurality of Iron-Zinc intermetallic compounds further comprises heating a first portion of the first steel workpiece, a second portion of the second steel workpiece, and a third portion of the third steel workpiece to at least about 500° C. allowing the zinc (Zn) coating to melt and the dissolution of iron Fe from the first, second, and third steel workpieces into the melted zinc (Zn) coating to form at least one of a plurality of Iron-Zinc intermetallic compounds;
cooling the first portion of the first steel workpiece and the second portion of the second steel workpiece to a first temperature further comprises cooling the first portion of the first steel workpiece, the second portion of the second steel workpiece, and the third portion of the third workpiece to a first temperature;
disposing the first steel workpiece in contact with the second steel workpiece such that the first portion of the first steel workpiece is aligned with the second portion of the second steel workpiece further comprising disposing the first steel workpiece in contact with the second steel workpiece and the second steel workpiece in contact with the third steel workpiece such that the first portion of the first steel workpiece is aligned with the second portion of the second steel workpiece and the third portion of the third steel workpiece; and
welding the first portion of the first steel workpiece to the second portion of the second steel workpiece further comprises welding the first portion of the first steel workpiece to the second portion of the second steel workpiece and the third portion of the third steel workpiece.
